(19) United States
(12) Patent Application Publication
(10) Pub. No.: US 2010/0054217 A1
(43) Pub. Date: Mar. 4, 2010

(54) REGISTRATION OF MULTIPLE CARE-OF-ADDRESSES

(75) Inventor: Desire Oulai, Longueuil (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/198,555

(22) Filed: Aug. 26, 2008

(51) Int. Cl. H04Q 7/24; H04Q 7/00

(52) U.S. Cl. 370/338

(57) ABSTRACT

Systems, methods, devices and software are described which provide for bulk registration of care-of-addresses (CoAs) associated with mobility signaling in communication networks. A mobile node transmits a bulk CoA registration message towards a correspondent node. The correspondent node receives the bulk CoA message, generates tokens associated with the CoAs and transmits the tokens back toward the mobile node.

### TECHNICAL FIELD

The present invention relates generally to communications networks and in particular to methods, devices, systems and software for registering multiple care-of-addresses in such communication networks.

### BACKGROUND

As the consumer electronics industry continues to mature, and the capabilities of processors increase, more devices have become available for public use that allow the transfer of data between devices and more applications have become available that operate based on their transferred data. Of particular note are the Internet and local area networks (LANs). These two innovations allow multiple users and multiple devices to communicate and exchange data between different devices and device types. With the advent of these devices and capabilities, users (both business and residential) increasingly desire to transmit data from mobile locations.

The first widespread deployment of a protocol to deal with these issues, was Internet Protocol version 4 (IPv4) in the early 1980's. IPv4 is a network layer protocol used to provide unique addressing to ensure that two computers communicating over the Internet can uniquely identify each other. IPv4 has a 32-bit addressing scheme which allows for 2³² (approximately 4.2 billion) potentially unique addresses. This limit of 2³² addresses is becoming a bottleneck as the need for more unique addresses will arrive in the foreseeable future. Additionally, IPv4 was not specifically designed to be efficient for mobile users. In fact, when IPv4 was implemented there were not a lot of mobile consumer devices that could communicate across the Internet as there are today. In this context, mobile IP equipment can be considered to be any a piece of equipment that is moveable, e.g., a laptop computer, cell phone or a Personal Digital Assistant (PDA), and that crosses boundaries between different networks while desiring to maintain connectivity or be allowed to connect to a foreign network. Accordingly, as this need and the need for more IP addresses developed, Internet Protocol version 6 (IPv6) was created and is now being implemented.

IPv6 uses a 128-bit addressing scheme which allows for 2¹²⁸ unique addresses, i.e., significantly more addresses than are provided for in IPv4. The addressing scheme in IPv6 is composed of two parts: a 64-bit host part and a 64-bit sub network prefix (subnet prefix). IPv6 is also more mobile friendly than IPv4, particularly with the addition of Mobile IPv6 (MIPv6). MIPv6 is a protocol that allows providing continuous IP service to a mobile node (MN). The mobility service is provided by a Home Agent (HA) and the MN has a Home Address (HoA) hosted on the HA. When the MN moves and attaches itself to a different access router, it acquires a new address, the Care-Of Address (CoA). The MN then sends a Binding Update (BU) to the HA in order to bind the CoA to the HoA. The HA replies with a Binding Acknowledgement (BA) and forwards each packet with HoA as the destination address to the CoA using a bidirectional tunnel. The mobile node is thus able to move without ending ongoing sessions since the HoA is unchanged.

Additionally, MIPv6 defines a route optimization process where the MN can directly send a BU to a corresponding node (CN) in order to use a direct path. Before sending the direct BU, the MN has to perform a Return Routability (RR) test in order to give to the CN a certain level of guarantee that it can be joined at the HoA and the new CoA. To perform RR, an MN 100 sends a Home Test Init (HoTI) message to the CN 104 through the HA 102 as shown in FIG. 1. The source address of the HoTI is HoA. Simultaneously, the MN 100 sends directly a CareOfTest Init (CoTI) message to the CN 104 with CoA as source address. The CN 104 replies to these two messages with a home token in the HoT message and a care-of token in the CoT message. If the MN 100 receives those two messages, that means the MN 100 is reachable via the HoA and the CoA. Then the MN 100 combines both tokens to obtain a binding management key (Kbm) used to send the BU. The CN 104 will then be able to determine that the Kbm was formed using both tokens.

However, conventional return routability procedures suffer from certain problems. For example, the current RR procedure for multiple CoAs associated with a single MN will result in a large amount of signaling overhead.

### SUMMARY

According to one exemplary embodiment, a method for bulk care-of-address (CoA) registration includes the steps of receiving the bulk CoA registration message, analyzing the bulk CoA registration message to extract a plurality of care-of-addresses associated with a mobile node (MN), generating a token for each of the care-of-addresses, and sending a care-of-token (CoT) message, including the corresponding token, toward the MN for each of the care-of-addresses.

According to another exemplary embodiment, a network node for receiving a bulk care-of-address (CoA) registration from a mobile node includes a processor in communications with a memory unit, wherein the processor is configured to receive the bulk CoA registration message, analyze the bulk CoA registration message to extract a plurality of care-of-addresses associated with the mobile node, generate a token for each of the care-of-addresses, and transmit a care-of-token (CoT) message, including the corresponding token, toward the MN for each of the care-of-addresses.

According to another exemplary embodiment, a method for bulk care-of-address (CoA) registration includes the steps of generating a bulk care-of-address registration message including a plurality of care-of-addresses, transmitting the bulk care-of-address registration message, receiving a token associated with at least some of the plurality of CoAs, generating a bulk binding update message including the plurality of tokens, and transmitting the bulk binding update message.

According to still another exemplary embodiment, a mobile node includes a processor in communications with a memory unit, wherein the processor is configured to generate a bulk care-of-address registration message including a plurality of care-of-addresses, transmit the bulk care-of-address registration message, receive a token associated with at least some of the plurality of CoAs, generate a bulk binding update message including the plurality of tokens, and transmit the bulk binding update message.

### BRIEF DESCRIPTION OF THE DRAWINGS

The accompanying drawings illustrate exemplary embodiments, wherein:

FIG. 1 depicts the message traffic flow for a conventional, MIPv6 return routabilty (RR) procedure;

FIG. 2(a) depicts a mobile node (MN) communicating with a correspondent node (CN) through a home agent;

FIG. 2(b) depicts a mobile node (MN) communicating with a correspondent node (CN) through an access router (AR);

FIG. 3 illustrates communication paths and a sequence for communications according to an exemplary embodiment;

FIG. 4(a) shows the contents of an exemplary bulk care-of-address registration message according to an exemplary embodiment;

FIG. 4(b) shows the contents of a Binding Identifier mobility option according to an exemplary embodiment;

FIG. 5(a) is a flowchart depicting a method for bulk CoA registration according to an exemplary embodiment;

FIG. 5(b) is a flowchart depicting another portion of a method for bulk CoA registration according to an exemplary embodiment;

FIG. 6 is a flowchart depicting a method for bulk CoA registration according to another exemplary embodiment; and

FIG. 7 depicts a node according to exemplary embodiments.

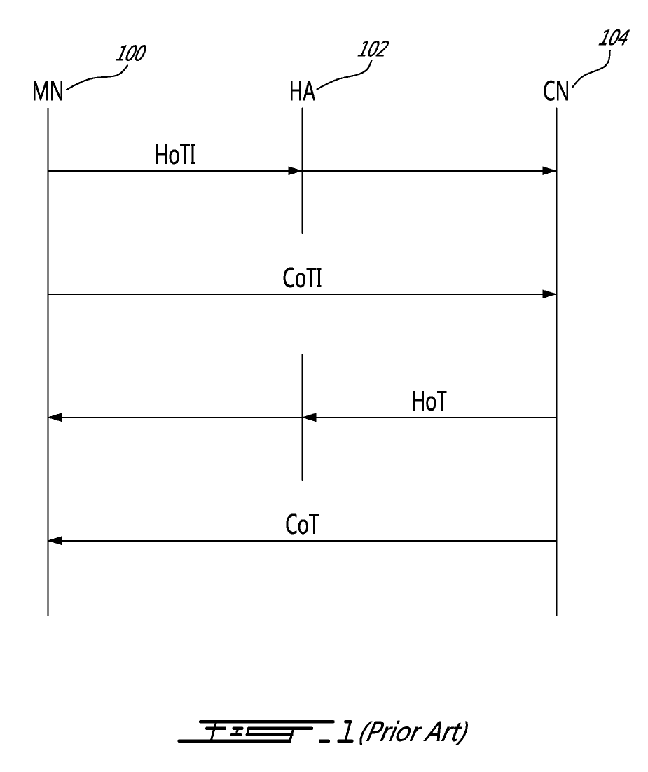

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

MIPv6 allows an MN to have several CoAs but to register only the primary CoA to the HA. To solve this issue, an IETF specification identifiable as draft-ietf-monami6-multiplecoa-07, “Multiple Care-of Addresses Registration”, April 2008 and referred to herein simply as the “multiple CoA” (MCoA) specification, the disclosure of which is incorporated here by reference, has been proposed to allow multiple CoAs to be bound to a single HoA. Using a flow binding message exchange, an MN is able to bind flows to its CoA. This is very useful, e.g., to add redundancy or load balancing. The MCoA specification also introduces bulk registration capabilities for the HA, which means that an MN can register several CoAs at the HA with a single BU/BA message exchange. This reduces the amount of signaling and the BU/BA delay which are associated with registering multiple CoAs.

However, the MCoA specification does not support bulk registration to the CN. Thus, the MN has to perform one RR test for each CoA. This implies more signaling, as a single RR test requires six messages. Accordingly, it would be desirable to provide systems, methods, devices and software to provide a method to perform bulk registration to the CN. This can be accomplished according to exemplary embodiments of the present invention by, for example, performing a single Home Test and combined CareOf Test exchange. The reachability of the MN at each CoA can also be checked according to these exemplary embodiments.

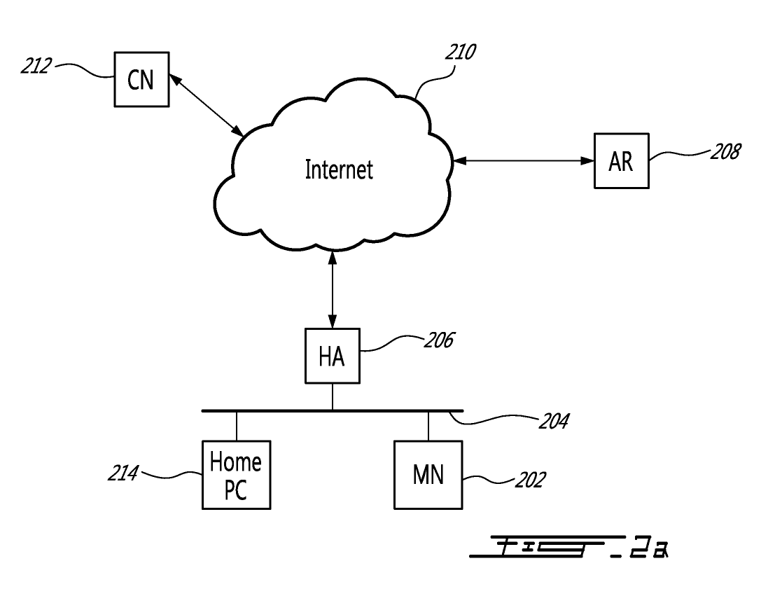

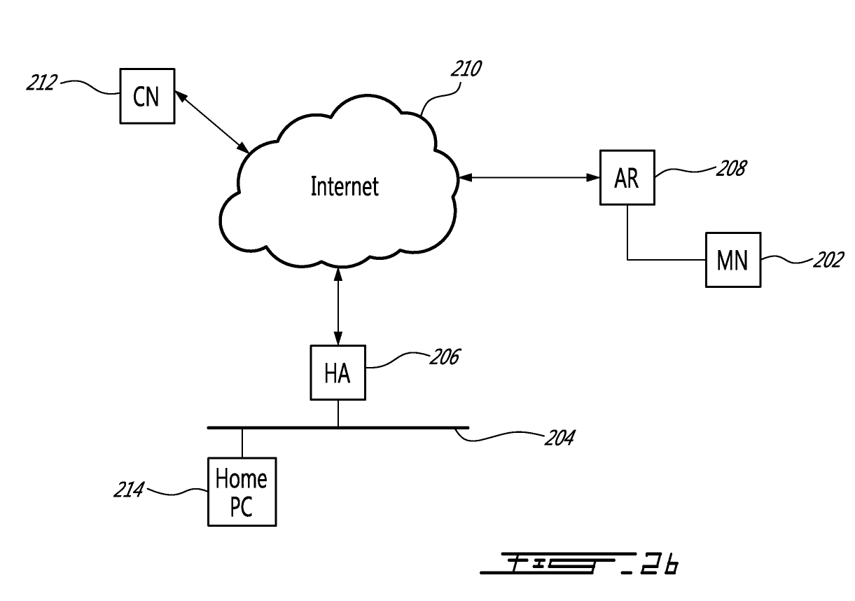

In order to provide some context for this discussion, a brief discussion of exemplary components used by a mobile network for communications will now be described according to FIGS. 2(a) and 2(b). FIG. 2(a) depicts an initial communication setup for a MN 202 that is currently attached to its home network 204. The home network 204 contains MN 202 and a home personal computer (PC) 214. MN 202 is in communication with correspondent node (CN) 212. Communications for MN 202 flow through its home agent 206 (typically a router), then to the Internet 210, ending at CN 212. Additionally, an access router (AR) 208 is also shown to be connected to the Internet. It is to be understood that there typically would be a plurality of routers (not shown) within Internet 210 through which communications between MN 202 and CN 212 flow. In FIG. 2(b) MN 202 has left its home network 204 and is now communicating to CN 212 through AR 208 and the Internet 210.

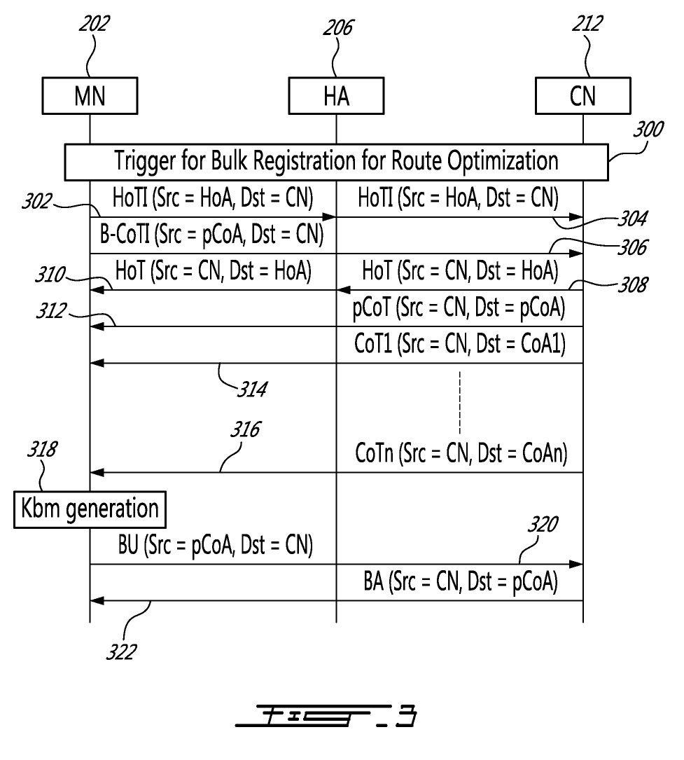

An exemplary signaling diagram associated with bulk CoA registration according to these exemplary embodiments is provided as FIG. 3. Therein, the signaling is preceded by a trigger for bulk registration for route optimization, as shown by block 300. Regarding the trigger for bulk registration 300, consider that the MN 202 has, for example, a policy to receive one traffic type on CoA1 and another traffic type on CoA2. The MN 202 can decide, based on parameters like delay and cost, to perform route optimization with the CN 212. In this case, the MN 202 needs to register both CoAs with CN 212. The bulk registration signaling according to this exemplary embodiment begins with the MN 202 sending a HoTI message 302 to the CN 212 through the HA 206 using a secure MIPv6 tunnel. The source address (Src) of the HoTI message 302 is the MN 202's HoA and the destination address (Dst) is the CN 212's address. The HA 206 forwards the HoTI message 302 as shown by reference numeral 304. The MN 202 sends a Bulk CoTI (B-CoTI) message 306 to the CN 212 having, as the source address, the primary CoA (pCoA) of the MN 202, i.e., the CoA that is currently registered with the HA 206.

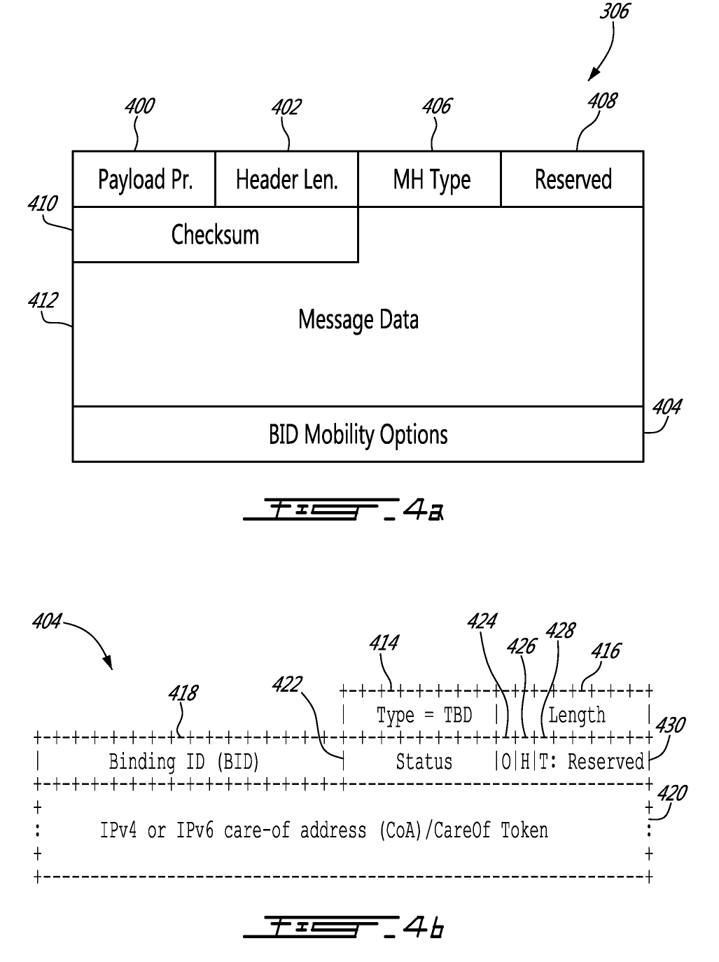

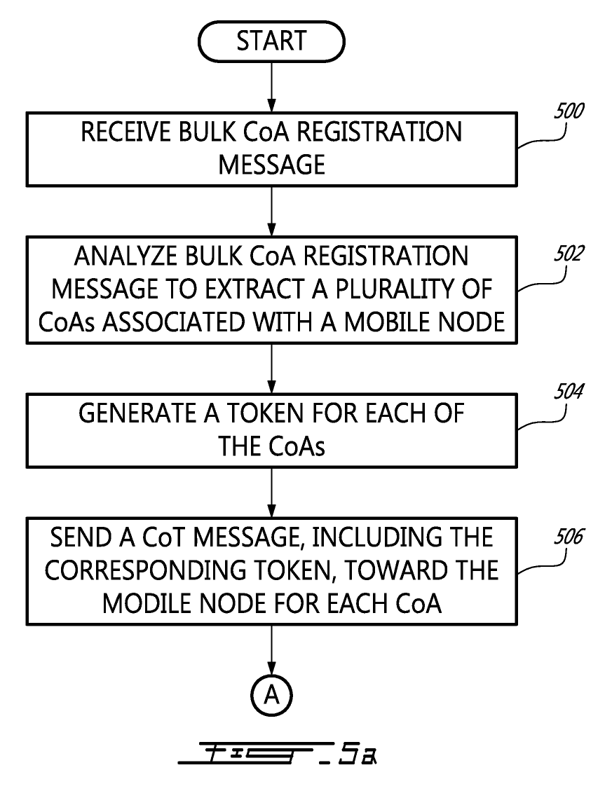

A B-CoTI message 306 according to an exemplary embodiment is illustrated in FIG. 4(a), which is depicted as a new type of IPv6 Mobility Header message according to this exemplary embodiment. Therein, a payload proto field 400 indicates the type of header which immediately follows this Mobility Header, and the header length field 402 indicates the length of this message 306, e.g., in octets, from which value the number of BID mobility options 404 can be derived. The MH type field 406 indicates the type of mobility header for the current message, for this exemplary embodiment the same MH type field value which is used for the CoTI message may also be used for the B-CoTI message. Reserved field 408 is set to zero and saved for future usage. Checksum field 410 is used by a receiver of the B-CoTI message 306 to compute a checksum to confirm error-free receipt of the message 306. The message data field 412 contains payload data associated with the B-CoTI message 306, including, for example, a reserved field (not shown), a Care-of-Init Cookie (not shown) and a plurality of Binding Identifier (BID) mobility options 404, e.g., one BID mobility option per CoA to be registered.

More specifically, the BID mobility option 404 can be modified to accommodate bulk registration functionality according to these exemplary embodiments, an example of such a modified BID mobility option will now be described with respect to FIG. 4(b). Therein, the Type field 414 indicates that this portion of the B-CoTI message 306 is a BID mobility option, the specific value of which is to be determined. The Length field 416 can, for example, be implemented as an 8-bit unsigned integer which represents the length of the BID mobility option in octets. The Binding ID field 418 is an, e.g., 16 bit, identifier assigned to the binding indicated in the CoA field 420. The Status field 422 can be used, for example, to carry error information related to the care-of address test in the B-CoTI message 306. The Overwrite (O) flag 424, when set, indicates that the MN 202 is requesting the recipient to replace all of its stored bindings to the values provided in binding entries sent in a Binding Update message. The Simultaneous Home and Foreign Binding (H) flag 426 indicates that the mobile node 202 is registering multiple bindings to the home agent 206 while it is attached to the home link and is valid only for a Binding Update sent to the home agent 206.

According to this exemplary embodiment, the flag section of the BID mobility option 404 is extended to include a new T flag or bit field 428. The T flag 428 indicates to the message recipient whether the CoA field 420 currently carries a Care-of-Address, e.g., if the T flag 428 is unset, or if it instead carries a Care-of-Address token (sometimes also referred to as a CareOfKeygen Token), e.g., if the T flag 428 is set. According to this exemplary embodiment, the T flags 428 will be unset in the B-CoTI message 306, since each of the BID mobility options 404 are intended to carry a CoA. The T flags 428 will be set in BU messages, since each of the BID mobility options 404 in BU messages are intended to carry a CareOf Token related to the CoA.

The Reserved field 430 is, e.g., a 5 bit field reserved for later use which is set to zero by the message transmitter and ignored by the message's recipient. The Care-of Address field 420 may, as described above, either carry a CoA or a CoA token depending upon the setting of the T flag 428. Having described, in detail, the contents of an exemplary B-CoTI message 306 according to an exemplary embodiment, the discussion now returns to the signaling diagram of FIG. 3.

Therein, having received the HoTI message 304, the CN 212 replies with a HoT message 308 addressed to the HoA, which message 308 includes the home token. The home agent 206 intercepts the HoT message 308 and forwards it (shown as message 310 in FIG. 3) to the MN 202. After generating a primary CareOf Token related to the pCoA, the CN 212 sends a primary CoT message 312 with pCoA as the destination address. The CN 212 keeps the list of all of the CoAs (e.g., referred to in FIG. 3 as CoA1-CoAn) that were included in the BID mobility options 404 of the B-CoTI message 306. The CN 212 can thus send a reply to each CoA in order to ensure that the MN 202 is reachable via all of the different CoAs. For example, after generating a CareOf Token related to the CoA1, the CN 212 sends a CoT1 message with CoA1 as its destination address, and continues to generate tokens and send such messages for each CoA until it sends the last one shown in FIG. 3 as CoTn message 316.

Next, the MN 202 generates the binding management key (Kbm) using the home and primary CareOf Tokens that it received from the CN 212 as indicated by block 318 in FIG. 3. The MN 202 sends a BU message 320 using the Kbm 318 and the pCoA as source address. The entire BU message 320 is protected using a hashing function and the Kbm 318. The BU message 320 also includes the BID mobility options 404 and the corresponding token for each additional CoA. The pCoA will typically not be included in any of the BID mobility options 404 in the BU message 320 as it is already present in the source address. Alternatively, however, the pCoA may be included in a BID mobility option 404 so that all CoAs are treated in the same manner. The CN 212 accepts the binding, according to this exemplary embodiment, only if all of the CoAs that were in the B-CoTI message 306 are represented in the BU message 320. If so, then the CN 212 sends a binding acknowledgement (BA) message 322 including the BID mobility options 404 for all the accepted CoAs. According to another exemplary embodiment, each CoA can be accepted individually by the CN 212, i.e., without having to reject or accept the entire BU message 320. This enables an MN 202 to register a subset of its CoAs.

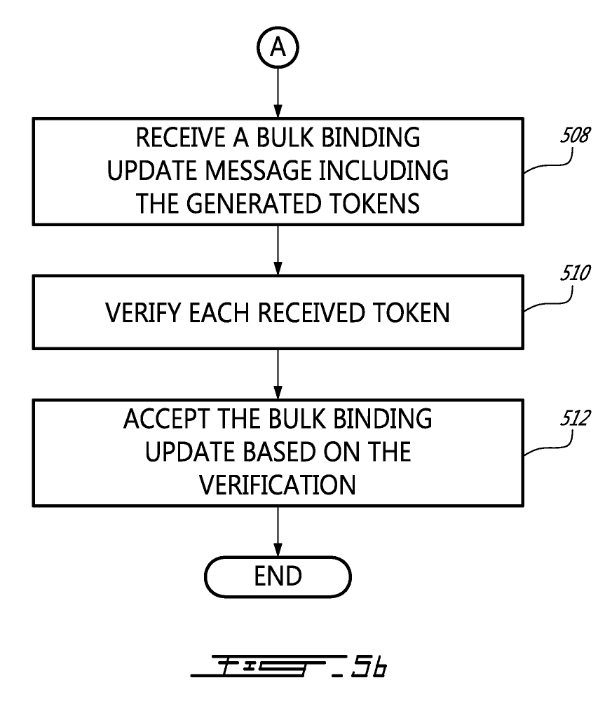

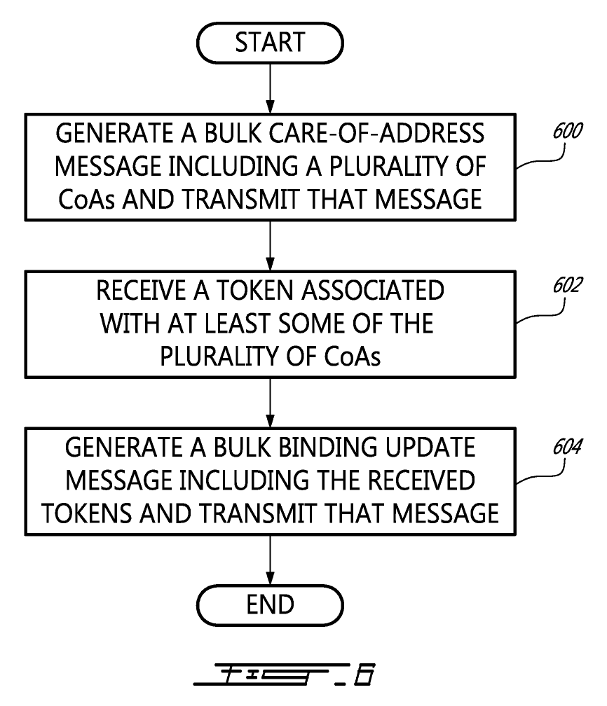

Accordingly, it can be seen from the foregoing exemplary embodiment that the present invention provides for a bulk RR procedure where a single message is sent from the MN 202 to the CN 212 with all of that MN 202's CoAs. The CN 212 then generates one token per CoA and performs a reachability test for each CoA. From the CN 212's perspective, a method for bulk care-of-address registration can include the steps illustrated in the flowchart of FIG. 5(a). Therein, a bulk care-of-address registration message (CoTI) is received at step 500. The bulk CoTI message is analyzed at step 502 to extract the plurality of CoA addresses associated with the MN, and a token is generated for each of the CoAs at step 504. A CoT message, including the corresponding token being returned to the MN 202 for each of the CoAs, is sent at step 506. The method can, according to exemplary embodiments, continue as shown in the flowchart of FIG. 5(b). Therein, the CN 212 receives a bulk binding update (BU) message including all of the previously generated tokens at step 508. The received tokens are verified at step 510 and, assuming that the verification process was successful, the BU is then accepted at step 512.

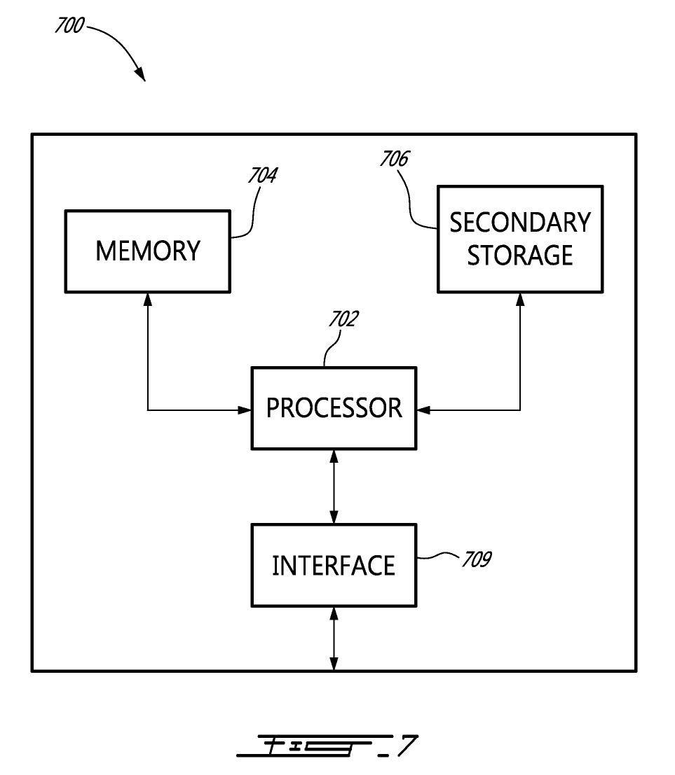

From, for example, an MN 202's perspective, a method for bulk care of address registration can include the steps illustrated in FIG. 6. Therein, at step 600, an MN 202 generates a bulk care-of-address message, including all of its CoA addresses, and transmits that message, e.g., toward a CN 212. In return, at step 602, the MN 202 receives a token for at least some of its CoAs, e.g., in a CoT message. Typically, the MN 202 will receive a token for each of its CoAs, unless the CN 212 receives CoAs which are invalid or otherwise unusuable, in which case the CN 212 will return a set of tokens which is fewer in number than the CoAs which it received. The MN 202 may then generate a bulk binding update message, including the received tokens, which it then transmits, e.g., toward the CN 212, as shown in step 604. As will be appreciated by those skilled in the art, methods such as that illustrated in FIGS. 5(a), 5(b) and 6 can be implemented, at least in part, in software. Thus, systems and methods for processing bulk CoA registrations according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

The exemplary embodiments described above provide for messages and protocols involving mobile nodes, access routers and other network nodes. An exemplary node 700 will now be described with respect to FIG. 7. Network node 700 can contain a processor 702 (or multiple processor cores), memory 704, one or more secondary storage devices 706 and an interface unit 708 to facilitate communications between network node 700 and the rest of the network. The memory can be used for storage of exemplary items described above such as the contents of a B-CoTI message or any other desirable information such as address lookup tables.

Bulk registration according to these exemplary embodiments provides, among other things, for a reduction in signaling overhead associated with route optimization given a plurality of CoAs associated with a particular MN. For example, a single route optimization procedure typically requires eight messages (including BA and BU messages) of which six pass through the radio (air) interface. Thus, for a situation wherein n CoAs need to be registered, a total of 8n messages (6n through the air interface) would conventionally have been needed to perform the registration. However, using the techniques described in these exemplary embodiments, the signaling associated with this exemplary registration procedure can be reduced to 7+n messages (with only 5+n passing through the air interface).

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for bulk care-of-address (CoA) registration comprising:
receiving a bulk CoA registration message;
analyzing said bulk CoA registration message to extract a plurality of care-of-addresses associated with a mobile node (MN);
generating a token for each of the care-of-addresses; and
sending a care-of-token (CoT) message, including the corresponding token, toward the MN for each of the care-of-addresses.

2. The method of claim 1, further comprising the steps of:
receiving a bulk binding update (BU) message including said generated tokens;
verifying each said received token; and
accepting the bulk BU message based on the verification.

3. The method of claim 2, wherein said step of accepting further comprises the step of:
accepting the bulk BU message only if all of the received tokens are successfully verified.

4. The method of claim 2, wherein said step of accepting further comprises the step of:
accepting individual care-of-addresses for registration if their respective tokens are verified regardless of whether all of the tokens in the BU message are verified.

5. The method of claim 1, wherein said bulk CoA registration message is an IPv6 mobility header message including a plurality of binding identification (BID) mobility option fields.

6. The method of claim 5, wherein each of said BID mobility option fields includes a bit flag which indicates whether a payload data portion of its respective BID mobility option field is carrying a care-of-address or a care-of-token.

7. A network node for receiving a bulk care-of-address (CoA) registration from a mobile node comprising:
a processor in communications with a memory unit;
wherein said processor is configured to receive a bulk CoA registration message, analyze said bulk CoA registration message to extract a plurality of care-of-addresses associated with the mobile node, generate a token for each of the care-of-addresses, and transmit a care-of-token (CoT) message, including the corresponding token, toward the MN for each of the care-of-addresses.

8. The network node of claim 7, wherein said processor is further configured to receive a bulk binding update (BU) message including said generated tokens, verify each said received token, and accept the bulk BU message based on the verification.

9. The network node of claim 8, wherein said processor is configured to accept the bulk BU message only if all of the received tokens are successfully verified.

10. The network node of claim 8, wherein said processor is configured to accept individual care-of-addresses for registration if their respective tokens are verified regardless of whether all of the tokens in the BU message are verified.

11. The network node of claim 7, wherein said bulk CoA registration message is an IPv6 mobility header message including a plurality of BID mobility option fields.

12. The network node of claim 11, wherein each of said BID mobility option fields includes a bit flag which indicates whether a payload data portion of its respective BID mobility option field is carrying a care-of-address or a care-of-token.

13. A method for bulk care-of-address (CoA) registration comprising:
generating a bulk care-of-address registration message including a plurality of care-of-addresses;
transmitting said bulk care-of-address registration message;
receiving a token associated with at least some of the plurality of CoAs;
generating a bulk binding update message including said tokens; and
transmitting said bulk binding update message.

14. The method of claim 13, wherein said bulk CoA registration message is an IPv6 mobility header message including a plurality of BID mobility option fields.

15. The method of claim 14, wherein each of said BID mobility option fields includes a bit flag which indicates whether a payload data portion of its respective BID mobility option field is carrying a care-of-address or a care-of-token.

16. A mobile node comprising:
a processor in communications with a memory unit;
wherein said processor is configured to generate a bulk care-of-address registration message including a plurality of care-of-addresses, transmit said bulk care-of-address registration message, receive a token associated with at least some of the plurality of CoAs, generate a bulk binding update message including said plurality of tokens, and transmit said bulk binding update message.

17. The mobile node of claim 16, wherein said bulk CoA registration message is an IPv6 mobility header message including a plurality of BID mobility option fields.

18. The mobile node of claim 17, wherein each of said BID mobility option fields includes a bit flag which indicates whether a payload data portion of its respective BID mobility option field is carrying a care-of-address or a care-of-token.
